(19) United States
(12) Patent Application Publication
(10) Pub. No.: US 2017/0004086 A1
(43) Pub. Date: Jan. 5, 2017

(54) CACHE MANAGEMENT METHOD FOR OPTIMIZING READ PERFORMANCE OF DISTRIBUTED FILE SYSTEM

(71) Applicant: Korea Electronics Technology Institute, Seongnam-si (KR)

(72) Inventors: Jae Hoon AN, Incheon (KR); Young Hwan KIM, Yongin-si (KR); Chang Won PARK, Hwaseong-si (KR)

(21) Appl. No.: 15/186,537

(22) Filed: Jun. 20, 2016

(30) Foreign Application Priority Data
Jun. 30, 2015 (KR) 10-2015-0092735

(51) Int. Cl. G06F 12/08

(52) U.S. Cl. CPC G06F 12/0862; G06F 2212/6026

(57) ABSTRACT

A cache management method for optimizing read performance in a distributed file system is provided. The cache management method includes: acquiring metadata of a file system; generating a list regarding data blocks based on the metadata; and pre-loading data blocks into a cache with reference to the list. Accordingly, read performance in analyzing big data in a Hadoop distributed file system environment can be optimized in comparison to a related-art method.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Jun. 30, 2015, and assigned Serial No. 10-2015-0092735, the entire disclosure of which is hereby incorporated by reference.

### TECHNICAL FIELD OF THE INVENTION

The present invention relates generally to a cache management method, and more particularly, to a cache management method which can optimize read performance in analyzing massive big data in the Hadoop distributed file system.

### BACKGROUND OF THE INVENTION

In establishing a distributed file system, a Hard Disk Drive (HDD) which has advantages of low price and big capacity in comparison to a relatively expensive Solid State Disk (SSD) is mainly used. The price of the SSD is gradually decreasing in recent years, but is still 10 times higher than the price of the same capacity hard disk at the present time.

Therefore, in the distributed file system, the SSD is used to serve as a cache of the HDD based on the speed of the SSD and the big capacity of the HDD, but there is a demerit that the distributed file system is influenced by the speed of the hard disk.

In addition, the I/O of the Hadoop distributed file system operates based on the Java Virtual Machine (JVM), and thus is slower than the I/O of the Native File System of Linux.

Therefore, a cache device may be applied to increase the speed of the I/O of the Hadoop distributed file system, but the cache device may not efficiently operate due to the JVM structure and big data of various sizes.

### SUMMARY OF THE INVENTION

To address the above-discussed deficiencies of the prior art, it is a primary aspect of the present invention to provide a cache management method which can optimize a reading speed of big data in a Hadoop distributed file system to minimize time required to analyze big data.

According to one aspect of the present invention, a cache management method includes: acquiring metadata of a file system; generating a list regarding data blocks based on the metadata; and pre-loading data blocks into a cache with reference to the list.

The pre-loading may include pre-loading data blocks requested by a client into the cache.

The pre-loading may include pre-loading other data blocks into the cache while a data block is being processed by the client.

The pre-loading may include pre-loading, into the cache, data blocks which are requested by the client, and data blocks which are referred to with the data blocks more than a reference number of times.

The file system may be a Hadoop distributed file system, and the cache may be implemented by using an SSD.

According to another aspect of the present invention, a server includes: a cache; and a processor configured to acquire metadata of a file system, generate a list regarding data blocks based on the metadata, and order to pre-load data blocks into the cache with reference to the list.

According to exemplary embodiments of the present invention as described above, read performance in analyzing big data in a Hadoop distributed file system environment can be optimized in comparison to a related-art method.

In addition, a cache device can be efficiently used by pre-loading blocks appropriate to use of the cache device in a Hadoop distributed file system environment, and thus the analyzing speed can be increased to the maximum.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view to illustrate a cache pre-load;

FIG. 2 is a view to illustrate a cache management method according to an exemplary embodiment of the present invention;

FIG. 3 is a view showing optimizing read performance by the cache management method shown in FIG. 2; and

FIG. 4 is a block diagram of a Hadoop server according to an exemplary embodiment of the present invention.

### DETAILED DESCRIPTION OF THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

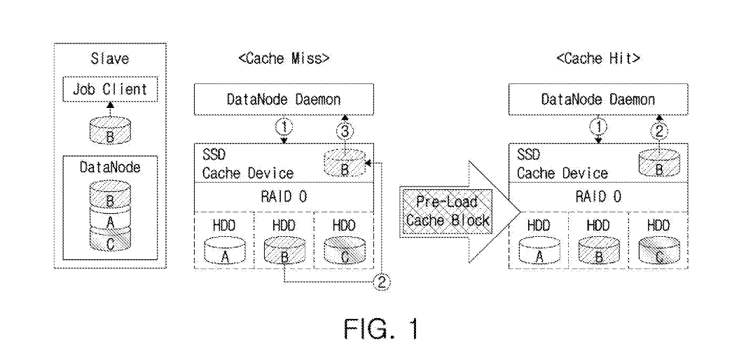

FIG. 1 is a view to illustrate a cache pre-load. The left view of FIG. 1 illustrates a state in which a client reads a data block “B,” the middle view of FIG. 1 illustrates a cache miss, and the right view of FIG. 1 illustrates a cache hit.

As shown in the middle view of FIG. 1, when the data block “B” that the client wishes to read is not loaded into a cache (cache miss), the data block “B” should be loaded into a Solid State Disk (SSD) cache from a Hard Disk Drive (HDD) and then should be read. In this case, a time delay occurs in the process of reading the data block “B” from the HDD and loading the data block “B” into the SSD cache.

However, as shown in the right view of FIG. 1, when the data block “B” that the client wishes to read is already loaded into the cache (cache hit), that is, when the data block “B” is pre-loaded into the SSD cache from the HDD, the time delay does not occur.

Accordingly, exemplary embodiments of the present invention propose a cache management method which can optimize a reading speed by pre-loading data blocks in a Hadoop distributed file system.

The cache management method according to an exemplary embodiment of the present invention provides a cache mechanism which can optimize read performance/speed in analyzing massive big data in a Hadoop distributed file system.

To achieve this, the cache management method according to an exemplary embodiment of the present invention pre-loads data blocks into a cache with reference to a list of data blocks necessary for analyzing big data in a Hadoop distributed file system environment. Accordingly, the rate of cache hit for the data blocks necessary for the analysis increases and read performance/speed increases, and eventually, time required to analyze the big data is minimized.

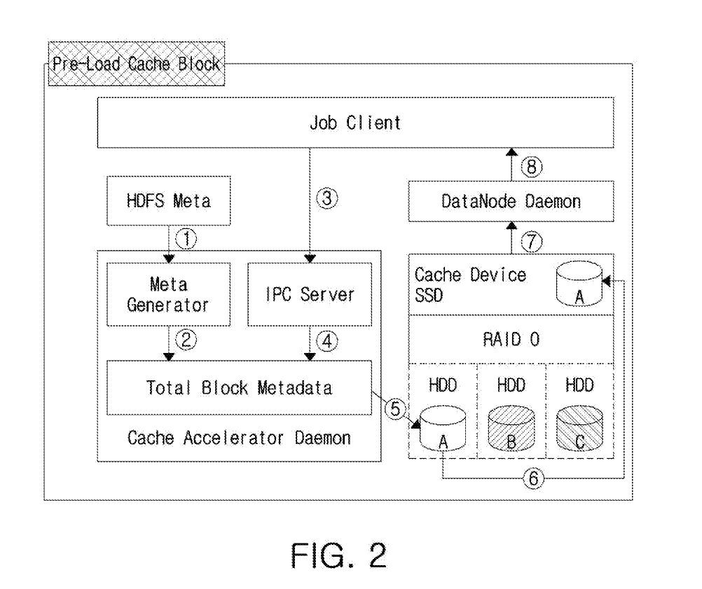

Hereafter, the process of the cache management method described above will be explained in detail with reference to FIG. 2. FIG. 2 is a view to illustrate the cache management method according to an exemplary embodiment of the present invention.

As shown in FIG. 2, Hadoop Distributed File System (HDFS) metadata is acquired according to a Hadoop file system check (Hadoop FSCK) command (\textcircled{1}).

A meta generator of Cache Accelerator Daemon (CAD) generates total block metadata based on the HDFS metadata acquired in process \textcircled{1} (\textcircled{2}). The total block metadata includes a list regarding HDFS blocks stored in the HDD.

Thereafter, HDFS block information to be used in MapReduce is transmitted from a job client to an IPC server of the CAD through IPC communication (\textcircled{3}).

Then, the IPC server retrieves the HDFS blocks requested in process \textcircled{3} from the total block metadata (\textcircled{4}). The retrieved blocks include HDFS blocks which are directly requested by the job client, and HDFS blocks which are referred to more than a reference number of times with the directly requested HDFS blocks.

Next, the CAD orders to load the HDFS blocks retrieved in process \textcircled{4} into the SSD cache according to a CLI command (\textcircled{5}). Accordingly, the retrieved HDFS blocks are loaded into the SSD cache from the HDD (\textcircled{6}).

Thereafter, the HDFS blocks loaded into the SSD cache are loaded (\textcircled{7}) and are delivered to the job client (\textcircled{8}). Since the cache hit is achieved by placing the HDFS blocks except for the first HDFS block delivered to the job client in the pre-loaded state, the HDFS block delivering speed is very fast.

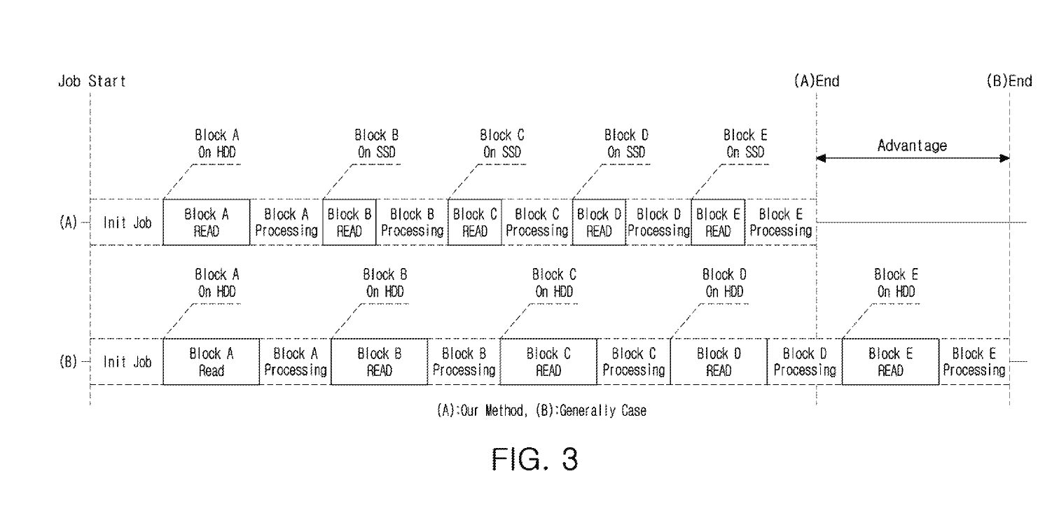

FIG. 3 illustrates a comparison of the cache management method of FIG. 2 with a related-art method to show the capability to optimize a reading speed in analyzing massive big data in the Hadoop distributed file system.

View (A) of FIG. 3 illustrates an HDFS data reading process by the cache management method of FIG. 2, and view (B) of FIG. 3 illustrates an HDFS data reading process by a normal method, not by the cache management method of FIG. 2.

As shown in FIG. 3, regarding blocks “B,” “C,” “D,” “E” other than the first HDFS data block “A”, less time is required to read due to the cache hit in the process of (A), whereas much time is required to read due to the cache miss in the process of (B). Therefore, it can be seen that there is a difference in time required to complete a job.

This is because, in the process of (A) of FIG. 3, the other data blocks are pre-loaded into the SSD cache from the HDD while the HDFS block is being processed by the job client.

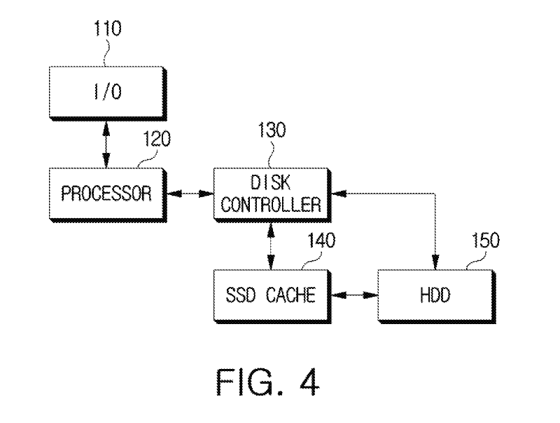

FIG. 4 is a block diagram of a Hadoop server according to an exemplary embodiment of the present invention. As shown in FIG. 4, the Hadoop server according to an exemplary embodiment of the present invention includes an I/O 310, a processor 120, a disk controller 130, an SSD cache 140, and an HDD 150.

The I/O 110 is connected to clients through a network to serve as an interface to allow job clients to access the Hadoop server.

The processor 120 generates total block metadata using the CAD shown in FIG. 1, and orders the disk controller 130 to pre-load data blocks requested by the job clients connected through the I/O 110 with reference to the generated total block metadata.

The disk controller 130 controls the SSD cache 140 and the HDD 150 to pre-load the data blocks according to the command of the processor 120.

The cache management method for optimizing the read performance of the distributed file system according to various exemplary embodiments has been described up to now.

In the above-described embodiments, the Hadoop distributed file system has been mentioned. However, this is merely an example of a distributed file system. The technical idea of the present invention can be applied to other file systems.

Furthermore, the SSD cache may be substituted with caches using other media.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A cache management method comprising:
acquiring metadata of a file system;
generating a list regarding data blocks based on the metadata; and
pre-loading data blocks into a cache with reference to the list.

2. The cache management method of claim 1, wherein the pre-loading comprises pre-loading data blocks requested by a client into the cache.

3. The cache management method of claim 2, wherein the pre-loading comprises pre-loading other data blocks into the cache while a data block is being processed by the client.

4. The cache management method of claim 1, wherein the pre-loading comprises pre-loading, into the cache, data blocks which are requested by the client, and data blocks which are referred to with the data blocks more than a reference number of times.

5. The cache management method of claim 1, wherein the file system is a Hadoop distributed file system, and
wherein the cache is implemented by using an SSD.

6. A server comprising:
a cache; and
a processor configured to acquire metadata of a file system, generate a list regarding data blocks based on the metadata, and order to pre-load data blocks into the cache with reference to the list.
